(19) United States
(12) Patent Application Publication
(10) Pub. No.: US 2025/0375840 A1
(43) Pub. Date: Dec. 11, 2025

(54) NANOMATERIAL BASED FILLER COMPOSITION FOR INCREASED EFFICIENCY WELDING

(71) Applicant: The United States of America, as Represented by the Secretary of the Navy, Crane, IN (US)

(72) Inventors: Denzel Bridges, Ventura, CA (US); Armen Kvryan, Glendale, CA (US)

(73) Assignee: The United States of America, as represented by the Secretary of the Navy, Arlington, VA (US)

(21) Appl. No.: 18/735,422

(22) Filed: Jun. 6, 2024

(51) Int. Cl. B23K 35/02; B22F 1/00; B22F 1/054; B22F 1/10; B23K 35/30

(52) U.S. Cl. CPC B23K 35/025; B22F 1/0547; B22F 1/09; B22F 1/10; B23K 35/302; B22F 2301/10; B22F 2301/15; B22F 2301/35; B22F 2302/10; B22F 2999/00

(57) ABSTRACT

Disclosed is a nanomaterial (NM)-based filler metal composition for welding alloys in an efficient manner. In an illustrative embodiment, the composition comprises a mixture of nickel (Ni) nanowires, cobalt (Co) nanoparticles, copper (Cu) nanowires, manganese (Mn) nanoparticles, iron (Fe) nanoparticles, and metal carbide (MC) nanomaterials dispersed in a non-aqueous vehicle. In an illustrative embodiment, the non-aqueous vehicle can be liquid solutions, gels, aerosols, polymer films, and the like. The non-aqueous binder prevents premature sintering of adjacent particles and helps prevent oxidation of oxidation-prone nanomaterials such as Cu and Fe. A method of welding using a nanomaterial (NM)-based filler metal composition is also provided.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 211427US02) is assigned to the United States Government and is available for licensing for commercial purposes. Licensing and technical inquiries may be directed to the Office of Technology, Naval Surface Warfare Center Port Hueneme Division, email: Alan.w.jaeger@navy.mil or phone (805) 205-0638.

### FIELD OF THE INVENTION

The field of invention relates generally to nanomaterials. More particularly, it pertains to a new nanomaterial (NM)-based filler metal for welding alloys in an efficient manner.

### BACKGROUND

Current methods of welding aluminum (Al) include, but are not limited to, arc welding, metal/tungsten inert gas (MIG/TIG) welding, and friction stir welding. Arc welding, MIG and TIG welding involve the use of an electric arc to locally melt two or more workpieces, thereby fusing them together. Friction stir welding uses a non-consumable rotating tool to generate heat at the interface between two workpieces, which softens the metal without melting it. These methods can be performed with or without a filler metal depending on a variety of factors, including the width of the gap between the workpieces and if dissimilar materials are being welded (i.e., Al and steel).

The filler metals typically used for welding Al alloys are aluminum-silicon based and occasionally copper-based. Filler metals typically come in wire, foil, rod, or powder form. In powder form, the particles are microscale, which means the particle diameter is typically 1-100 micrometers. Powder-based filler metals have the distinct advantage of being able to accommodate complex part geometries, however, the size and melting point of the particle can be an inhibition.

Nanomaterials are typically materials that have one or more dimensions or features that are 100 nanometers (nm) or less. Nanomaterials include particles (spherical or other shapes), rods, and wires (diameter satisfies the nanoscale dimension criteria), films that are 100 nm or less, and porous materials where the pores are 100 nm or less. Nanomaterials have been used in the prior art as the sole filler metal in a metal joining process, using one particle shape (i.e., spherical particles) and occasionally a multimodal size distribution. Occasionally, two particle shapes are utilized, with the most common shapes being nanowires and spherical nanoparticles. In general, the number of elements in the nanomaterial filler metal are two per nanomaterial. When used as filler metals, printable inks, and additive manufacturing feedstock, nanomaterials have the advantage of a lower processing temperature as compared to traditional microscale powders and wires due to size-dependent melting point depression via the Gibbs-Thompson effect.

It is known to use metal carbide nanoparticles to either strengthen welds or to facilitate the welding of metals that are difficult to weld such as Al alloy 7075. Furthermore, particles used for strengthening welds tend to already be embedded in a more traditional filler metal like a wire, foil or rod.

### SUMMARY OF THE INVENTION

The present invention relates to a new nanomaterial (NM)-based filler metal composition for welding alloys in an efficient manner. In an illustrative embodiment, the composition comprises a mixture of nickel (Ni) nanowires, cobalt (Co) nanoparticles, copper (Cu) nanowires, manganese (Mn) nanoparticles, iron (Fe) nanoparticles, and metal carbide (MC) nanomaterials dispersed in a non-aqueous vehicle. In an illustrative embodiment, the non-aqueous vehicle can be liquid solutions, gels, aerosols, polymer films, and the like. The non-aqueous binder prevents premature sintering of adjacent particles and helps prevent oxidation of oxidation-prone nanomaterials such as Cu and Fe. A method of welding using a nanomaterial (NM)-based filler metal composition is also provided.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 shows an illustration of the method of welding using a nanomaterial (NM)-based filler metal composition.

FIG. 2 shows an illustration of the difference in green density of a pure nanowire mixture powder and a nanowire-nanoparticle mixture.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

Generally, provided is a nanomaterial (NM)-based filler metal composition for welding alloys, comprising nickel (Ni) nanowires, cobalt (Co) nanoparticles, copper (Cu) nanowires, manganese (Mn) nanoparticles, iron (Fe) nanoparticles, and metal carbide (MC) nanomaterials dispersed in a non-aqueous vehicle. In an illustrative embodiment, the alloy is a 6xxx series aluminum alloy. In an illustrative embodiment, the alloy is a 5xxx series aluminum alloy. In an illustrative embodiment, the non-aqueous vehicle can include, but is not limited to, liquid solutions, gels, aerosols, and polymer films. The non-aqueous binder prevents premature sintering of adjacent particles and helps prevent oxidation of oxidation-prone nanomaterials such as Cu and Fe. The composition ranges of the filler metal are shown in Table 1.

TABLE 1
Tiered table summarizing the composition
of the fller metal in wt %

| Material | Composition | |
|---|---|---|
| Solid nanomaterials | 60.0-85.0 | wt % |
| Hi entropy alloy | 97.0-99.5 | wt % |
| Ni nanowires | 19.9 | wt % |
| Co nanoparticles | 19.9 | wt % |
| Cu nanowires | 31.2-37.2 | wt % |
| Mn nanoparticles | 18.3-23.5 | wt % |
| Fe nanoparticles | 4.7 | wt % |
| MC nanoparticles | 0.5-3.0 | wt % |
| Non-aqueous vehicle | 0-40.0 | wt % |

In an illustrative embodiment, provided is a nanomaterial-based filler metal composition for welding alloys comprising: nickel nanowires, cobalt nanoparticles, copper nanowires, manganese nanoparticles, iron nanoparticles, and metal carbide nanomaterials dispersed in a non-aqueous vehicle.

In an illustrative embodiment, the alloy is a 6xxx series aluminum alloy. In an illustrative embodiment, the alloy is a 5xxx series aluminum alloy. In an illustrative embodiment, the non-aqueous vehicle is selected from the list consisting of liquid solutions, gels, aerosols, and polymer films. In an illustrative embodiment, the non-aqueous binder prevents premature sintering of adjacent particles and helps prevent oxidation of oxidation-prone nanomaterials. In an illustrative embodiment, the composition further comprises 60.0-85.0 wt % solid nanomaterials and 0-40.0 wt % non-aqueous vehicle. In an illustrative embodiment, the composition further comprises 97.0-99.5 wt % high entropy alloy. In an illustrative embodiment, the composition further comprises 19.9 wt % nickel nanowires, 19.9 wt % cobalt nanoparticles, 32.1-37.2 wt % copper nanowires, 18.3-23.5 wt % manganese nanoparticles, 4.7 wt % iron nanoparticles, 0.5-3.0 wt % metal carbide, and 0-40.0 wt % non-aqueous vehicle.

In an illustrative embodiment, provided is a nanomaterial-based filler metal composition for welding alloys comprising: 60.0-85.0 wt % solid nanomaterials, wherein the solid nanomaterials comprise nickel nanowires, cobalt nanoparticles, copper nanowires, manganese nanoparticles, iron nanoparticles, and metal carbide nanomaterials; and 0-40.0 wt % non-aqueous vehicle.

In an illustrative embodiment, the alloy is a 6xxx series aluminum alloy. In an illustrative embodiment, the alloy is a 5xxx series aluminum alloy. In an illustrative embodiment, the non-aqueous vehicle is selected from the list consisting of liquid solutions, gels, aerosols, and polymer films. In an illustrative embodiment, the non-aqueous binder prevents premature sintering of adjacent particles and helps prevent oxidation of oxidation-prone nanomaterials. In an illustrative embodiment, the composition further comprises 97.0-99.5 wt % high entropy alloy. In an illustrative embodiment, the composition further comprises 19.9 wt % nickel nanowires, 19.9 wt % cobalt nanoparticles, 32.1-37.2 wt % copper nanowires, 18.3-23.5 wt % manganese nanoparticles, 4.7 wt % iron nanoparticles, 0.5-3.0 wt % metal carbide, and 0-40.0 wt % non-aqueous vehicle.

In an illustrative embodiment, provided is a composition comprising: 97.0-99.5 wt % high entropy alloy; and 0.5-3.0 wt % nanomaterial-based filler metal composition; the nanomaterial-based filler metal composition comprising: 60.0-85.0 wt % solid nanomaterials and 0-40.0 wt % non-aqueous vehicle; the solid nanomaterials comprising: 19.9 wt % nickel nanowires, 19.9 wt % cobalt nanoparticles, 32.1-37.2 wt % copper nanowires, 18.3-23.5 wt % manganese nanoparticles, 4.7 wt % iron nanoparticles, and 0.5-3.0 wt % metal carbide.

In an illustrative embodiment, the high entropy alloy is a 6xxx series aluminum alloy. In an illustrative embodiment, the alloy is a 5xxx series aluminum alloy. In an illustrative embodiment, the non-aqueous vehicle is selected from the list consisting of liquid solutions, gels, aerosols, and polymer films. In an illustrative embodiment, the non-aqueous binder prevents premature sintering of adjacent particles and helps prevent oxidation of oxidation-prone nanomaterials.

In an illustrative embodiment, the composition comprises a NiCoCuMnFe-based nanocomposite filler. In an illustrative embodiment, the composition comprises 60.0-85.0 wt % solid nanomaterials and 0-40.0 wt % non-aqueous vehicle. In an illustrative embodiment, the composition comprises 97.0-99.5 wt % high entropy alloy. In an illustrative embodiment, the composition comprises 19.9 wt % Nickel nanowires. In an illustrative embodiment, the composition comprises 19.9 wt % Cobalt nanoparticles. In an illustrative embodiment, the composition comprises 32.1-37.2 wt % Copper nanowires. In an illustrative embodiment, the composition comprises 18.3-23.5 wt % Manganese nanoparticles. In an illustrative embodiment, the composition comprises 4.7 wt % Iron nanoparticles. In an illustrative embodiment, the composition comprises 0.5-3.0 wt % metal carbide nanometaterials. In an illustrative embodiment, the non-aqueous vehicle is 0-40.0 wt % non-aqueous vehicle selected from the group consisting of liquid solutions, gels, aerosols, and polymer films.

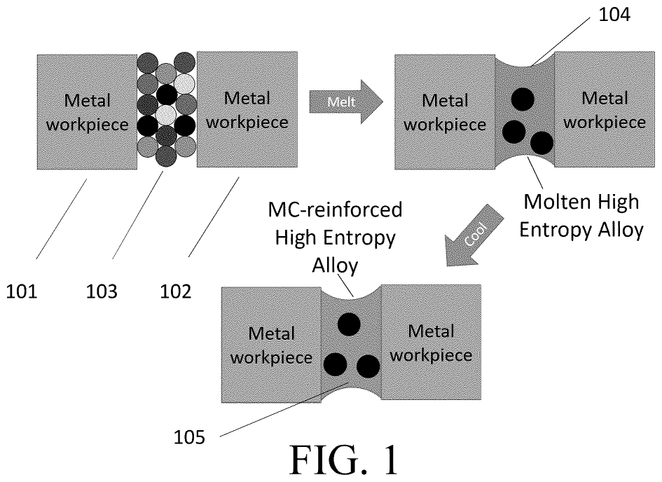

FIG. 1 shows an illustration of the method of welding using a nanomaterial (NM)-based filler metal composition. In an illustrative embodiment, provided is a method of welding using a nanomaterial (NM)-based filler metal composition. The method comprises the steps of providing a first 101 and second 102 metal workpiece for welding; applying a nanomaterial (NM)-based filler metal composition 103 as described above; performing a welding technique to the nanomaterial (NM)-based filler metal composition; wherein the non-aqueous vehicle evaporates or decomposes and the lowest melting temperature components soften and/or melt; wherein the higher melting point materials dissolve into the melt and fuse to adjacent particles 104; and continuing the welding technique or applying a post-weld heat treatment to permit the joint comprising the first and second metal workpiece and the nanomaterial (NM)-based filler metal composition to homogenize into a particle-strengthened NiCoCuMnFe high entropy alloy (HEA) 105 via in-situ alloying.

When welding occurs, the non-aqueous vehicle evaporates or decomposes depending on the components, thereby leaving as little residue as possible. After welding, when substantially only the nanomaterials remain, the lowest melting temperature components begin to soften and/or melt, allowing the higher melting point materials to dissolve into the melt and otherwise fuse to adjacent particles. During the course of the welding or during post-weld heat treatment, the joint homogenizes into a particle-strengthened NiCoCuMnFe high entropy alloy (HEA) via in-situ alloying. To take full advantage of the depressed melting temperature of the nanomaterials, the heating rate should be sufficiently high enough to mitigate premature sintering of adjacent particles.

As described above, the heated metal nanomaterials melt during the welding process, but due to the higher melting temperature of the metal carbide nanometaterials, the metal carbide nanometaterials will remain solid. The result will be a metal carbide-reinforced high entropy alloy joint.

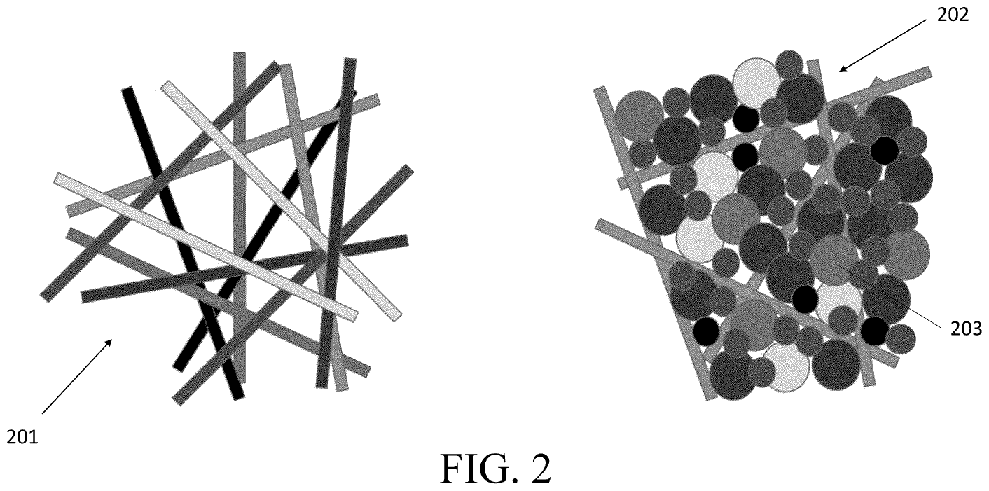

The advantages and new features of this invention are as follows:
Most particle mixtures use only one particle geometry (e.g. spherical nanoparticles or cylindrical nanowires). Mixing nanoparticles and nanowires can increase the green density of powder and lower the processing temperature of the filler metal. This is illustrated in FIG. 2, which shows an illustration of the difference in green density of a pure nanowire mixture powder 201 and a nanowire-nanoparticle mixture 202. The homogenization of the nanomaterial (NM)-based filler metal composition 203 is evident as compared to traditional welding methods.
Use of nanomaterials over micromaterials requires less energy input, lower temperature, and less processing time for fusion resulting in lower energy cost and lower environmental impact associated with processing.
Due to Gibbs-Thomson melting point depression, nanomaterials do not require melting point depressant elements that can compromise material integrity and increase processing time
Due to the high diffusivity of nanomaterials, in-situ alloying is potentially easier to achieve and reduces the need to develop prealloyed powders for welding, brazing and additive manufacturing
Using nanomaterial-based filler metals can produce higher yield and fracture strength compared to traditional materials
Distorted lattice structure of high entropy alloys adds corrosion resistance and crack resistance
The proposed filler metal would produces a HEA that contains up to 75% more Cu and up to 43% less Mn-rich than NiCoCuMnFe HEAs seen in prior art.

Nanowires have been shown to be less thermally stable than their nanoparticle counterpart. This thermal instability can help to further depress the melting temperature and required processing time.

In an illustrative embodiment, the composition and method disclosed herein can be used as an interlayer for dissimilar welding/brazing with steel or nickel alloys. In an illustrative embodiment, the composition and method disclosed herein can be used for turbine blade repair. In an illustrative embodiment, the composition and method disclosed herein can be used for additive manufacturing feedstock material. In an illustrative embodiment, the composition and method disclosed herein can be used for assembly of components with high operating temperatures. In an illustrative embodiment, the composition and method disclosed herein can be used for additive manufacturing post processing. In an illustrative embodiment, the composition and method disclosed herein can be used for additive manufacturing repair.

In an illustrative embodiment, the composition and method disclosed herein can be used for additive manufacturing, including for feedstock material and for repair of complex shapes. In an illustrative embodiment, the composition and method disclosed herein can be used for welding crack repair, dissimilar welding, cold spray, and sacrificial anode placement.

Although the invention has been described in detail with reference to certain preferred embodiments, variations and modifications exist within the spirit and scope of the invention as described and defined in the following claims.

1. A nanomaterial-based filler metal composition for welding alloys comprising:
nickel nanowires, cobalt nanoparticles, copper nanowires, manganese nanoparticles, iron nanoparticles, and metal carbide nanomaterials dispersed in a non-aqueous vehicle.

2. The nanomaterial-based filler metal composition for welding alloys of claim 1, wherein said alloy is a 6xxx series aluminum alloy.

3. The nanomaterial-based filler metal composition for welding alloys of claim 1, wherein said alloy is a 5xxx series aluminum alloy.

4. The nanomaterial-based filler metal composition for welding alloys of claim 1, wherein said non-aqueous vehicle is selected from the list consisting of liquid solutions, gels, aerosols, and polymer films.

5. The nanomaterial-based filler metal composition for welding alloys of claim 1, wherein said non-aqueous binder prevents premature sintering of adjacent particles and helps prevent oxidation of oxidation-prone nanomaterials.

6. The nanomaterial-based filler metal composition for welding alloys of claim 1, wherein said composition further comprises
60.0-85.0 wt % solid nanomaterials and
0-40.0 wt % non-aqueous vehicle.

7. The nanomaterial-based filler metal composition for welding alloys of claim 1, wherein said composition further comprises 97.0-99.5 wt % high entropy alloy.

8. The nanomaterial-based filler metal composition for welding alloys of claim 1, wherein said composition further comprises
19.9 wt % nickel nanowires,
19.9 wt % cobalt nanoparticles,
32.1-37.2 wt % copper nanowires,
18.3-23.5 wt % manganese nanoparticles,
4.7 wt % iron nanoparticles,
0.5-3.0 wt % metal carbide, and
0-40.0 wt % non-aqueous vehicle.

9. A nanomaterial-based filler metal composition for welding alloys comprising:
60.0-85.0 wt % solid nanomaterials, wherein said solid nanomaterials comprise
nickel nanowires, cobalt nanoparticles, copper nanowires, manganese nanoparticles, iron nanoparticles, and metal carbide nanomaterials; and
0-40.0 wt % non-aqueous vehicle.

10. The nanomaterial-based filler metal composition for welding alloys of claim 9, wherein said alloy is a 6xxx series aluminum alloy.

11. The nanomaterial-based filler metal composition for welding alloys of claim 9, wherein said alloy is a 6xxx series aluminum alloy.

12. The nanomaterial-based filler metal composition for welding alloys of claim 9, wherein said non-aqueous vehicle is selected from the list consisting of liquid solutions, gels, aerosols, and polymer films.

13. The nanomaterial-based filler metal composition for welding alloys of claim 9, wherein said non-aqueous binder prevents premature sintering of adjacent particles and helps prevent oxidation of oxidation-prone nanomaterials.

14. The nanomaterial-based filler metal composition for welding alloys of claim 9, wherein said composition further comprises 97.0-99.5 wt % high entropy alloy.

15. The nanomaterial-based filler metal composition for welding alloys of claim 9, wherein said composition further comprises
19.9 wt % nickel nanowires,
19.9 wt % cobalt nanoparticles,
32.1-37.2 wt % copper nanowires,
18.3-23.5 wt % manganese nanoparticles,
4.7 wt % iron nanoparticles,
0.5-3.0 wt % metal carbide, and
0-40.0 wt % non-aqueous vehicle.

16. A composition comprising:
97.0-99.5 wt % high entropy alloy; and
0.5-3.0 wt % nanomaterial-based filler metal composition;
said nanomaterial-based filler metal composition comprising:
60.0-85.0 wt % solid nanomaterials and 0-40.0 wt % non-aqueous vehicle;
said solid nanomaterials comprising:
19.9 wt % nickel nanowires,
19.9 wt % cobalt nanoparticles,
32.1-37.2 wt % copper nanowires,
18.3-23.5 wt % manganese nanoparticles,
4.7 wt % iron nanoparticles, and
0.5-3.0 wt % metal carbide.

17. The composition of claim 16, wherein said high entropy alloy is a 6xxx series aluminum alloy.
The composition of claim 16, wherein said alloy is a 5xxx series aluminum alloy.

18. The composition of claim 16, wherein said non-aqueous vehicle is selected from the list consisting of liquid solutions, gels, aerosols, and polymer films.

19. The composition of claim 16, wherein said non-aqueous binder prevents premature sintering of adjacent particles and helps prevent oxidation of oxidation-prone nanomaterials.
